(19) United States
(12) Patent Application Publication
(10) Pub. No.: US 2005/0025890 A1
(43) Pub. Date: Feb. 3, 2005

(54) Method for manufacturing flame-retardant blanket

(76) Inventor: Ying-Ming Cheng, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/872,355

(22) Filed: Jun. 22, 2004

(30) Foreign Application Priority Data
Jul. 30, 2003 (TW) 092120751

(51) Int. Cl. B05D 3/02

(52) U.S. Cl. 427/372.2; 427/430.1

(57) ABSTRACT

The present invention discloses a method for manufacturing a flame-retardant blanket, in which a non-woven fabric carrier made from natural or synthetic fibers or an admixture thereof is provided. The non-woven fabric carrier can be saturated with an intumescent flame-retardant material by immersing therein or being sprayed on. After curing, a blanket with properties of resilience, softness, soundproofing, heat insulation and flame retardation is obtained. This flame-retardant blanket can serve as a coat covering on objects, or fillers or flame-retardant material of partition walls. The flame-retardant blanket of the present invention can be more easily cut and applied than the conventional.

### BACKGROUND OF THE INVENTION

1. Field of the Invention

The present invention relates to a method for manufacturing a flame-retardant blanket. Particularly, the flame-retardant blanket of the present invention can be independently used and no additional object for coating is necessary. Accordingly, the whole blanket is flame-retardant and suitable for covering on an object or serving as fillers or flame-retardant material of partition walls.

2. Related Prior Technologies

Currently, materials for resisting fire, noise and heat are widely applied to constructions. These materials are generally classified into hard materials and soft materials. Examples of the hard materials include calcium silicate, asbestos cement, cement, cement/wood, plasterboard, fiber/cement, vermiculite/calcium silicate, magnesium oxide, rock wool, aluminum hydroxide, mineral fibers, glass fibers, lime, plywood, and other blended materials. Though such inorganic materials are cheaper, they seem too rigid, heavy and fragile to serve as flame-retardant or soundproof materials which might be applied properly to uneven spaces.

Examples of the soft materials include asbestos, glass wool, calcium silicate fibers, carbon fibers, mineral asbestos, etc. Though the soft materials are lightweight and resilient, disadvantages thereof should be considered, too. For example, asbestos is a carcinogen; calcium silicate and glass fibers have poor strength and resilience and the fine dusts thereof may injure the workers; and the carbon fibers are expensive.

A solution for the above problems is intumescent fire-resistant paint which can be coated on surfaces of constructions. Since the intumescent fire-resistant paint was first disclosed by Tramm's patent in 1938, plentiful modifications in formulae and components were developed. So far, the intumescent fire-resistant paint is considered the best option in passively protecting constructions. The paint is primarily coated on steel material, as U.S. Pat. No. 5,225,464 (1993) and U.S. Pat. No.6,245,842 (2001) described.

The fire-resistant coating containing special components may dehydrate, carbonize and expand as large as 10-100 times when suffering flame or high heat. The resultant carbon multi-layered structure is a sponge-like porous structure, which can effectively retard flame and insulate heat so as to protect the covered objects. Now the intumescent fire-resistant coat has been widely applied. However, only the surface coated with the fire-resistant paint can be protected, but the other surfaces without coating can still burn, and eventually the whole object is destroyed.

To ameliorate the flame-retardant or fire-resistant effect in construction, the present invention therefore provides a method for manufacturing a flame-retardant blanket.

### SUMMARY OF THE INVENTION

The flame-retardant blanket of the present invention comprises a non-woven fabric carrier made from natural or synthetic fibers or an admixture thereof. Then the non-woven fabric carrier is saturated with an intumescent flame-retardant material by immersing therein or being sprayed on. After curing, a blanket with properties of resilience, softness, soundproof, heat insulation and flame retardation is obtained. The flame-retardant blanket of the present invention can be more easily cut and applied than the conventional materials.

### BRIEF DESCRIPTION OF THE DRAWINGS

FIG. 1 shows a process for manufacturing the flame-retardant blanket in accordance with the first embodiment of the present invention.

FIG. 2 shows a process for manufacturing the flame-retardant blanket in accordance with the second embodiment of the present invention.

FIG. 3 shows a process for manufacturing the flame-retardant blanket in accordance with the third embodiment of the present invention.

### DETAILED DESCRIPTION OF THE PREFERRED EMBODIMENTS

The flame-retardant blanket of the invention is composed of an intumescent flame-retardant material and a non-woven fabric carrier. The intumescent flame-retardant material primarily includes components as follows:

1. Inorganic Acid

At high temperature, the inorganic acid may result in dehydration and carbonization of the non-woven fabric carrier and carbohydrate as one of components. It is not necessary for the inorganic acid to exist with a free acid and can be an inorganic acid such as phosphoric acid, polyphosphoric acid, sulfuric acid, boric acid, silicic acid; or salts, esters or amines of the aforementioned inorganic acids; for example, mono-ammonium phosphate, diammonium phosphate and other phosphate, or salts such as ammonium chloride, ammonium sulfate, ammonium borate, borax, antimony trioxide and sodium silicate. These salts decompose and form respective free acids at 90-250° C., and further catalyze the carbonization of the non-woven carrier and carbohydrate.

2. Carbohydrate

The carbohydrate can be decomposed, dehydrated and carbonized by the abovementioned inorganic acids at high temperature to form a carbonized layer with properties of heat insulation and refractory. This layer can protect objects covered below from destruction of flame or high heat. The carbohydrate is primarily poly-carbohydrate with polyhydroxy compounds; for example, starch, dextrin, mannitol, pentaerythritol, dipentaerythritol, tripentaerythritol, resin comprising hydroxyl, and other polyol phenol.

3. Blowing Agent

The blowing agent can release nonflammable gas when suffering heat. The nonflammable gas serves as an insulator and dilutes the air, so that oxidation and combustion of materials can be alleviated. On the other hand, the carbonized layer of the carbohydrate can expand to form a three-dimensional sponge-like structure which can increase thickness of the carbonized layer and reinforce effects of retarding flame and insulation. The blowing agent primarily comprises precursor of nonflammable gas such as nitrogen, ammonium, carbon dioxide, vapor and hydrogen halide. Examples of the blowing agent include urea, melamine, dicyanodiamine, hexamethylene tetramine, chlorinated paraffin, carbonate, azo compound, N-nitroso compound, dinitroso penta tetramine and ammonium phosphate, melamine phosphate, polyurethane, melamine formaldehyde resin and dicyandiamide formaldehyde resin. Other inorganic ammonium salts having functions of dehydration and releasing nonflammable gas can also be applied; for example, phosphate and sulfate mentioned in component 1.

4. Binder

The binder is provided to uniformly disperse the above components therein so as to be effectively filled in porous space of the carrier and firmly attached on surfaces of the carrier, which may result in superior nonflammable and expansive effect of the flame-retardant material in flame or high heat. Examples of the binder include water-soluble resin such as polyvinyl acetate emulsion, polyacrlate emulsion, urea-formaldehyde resin, melamine-formaldehyde resin and poly vinyl alcohol in various formulae. Additionally, an admixture of sodium silicate and an organic resin emulsion may be suitable. For the waterproof flame-retardant blanket, a nitro-resin such as melamine-formaldehyde resin, polyurethane resin, polyamide resin and acrylonitrile copolymer can exhibit properties of waterproofing and chemical resistance. Moreover, physical-mechanical properties of the flame-retardant blanket are improved. In addition, epoxy resin, phenolic resin, silicone resin and alkyd resin can be selected according to the usage of the blanket.

5. Auxiliary

Auxiliaries with specific functions can be added, optionally. For example, thickeners including carboxymethyl cellulose can enhance absorption of the flam-retardant materials by the carrier; emulsifiers can uniformly disperse the components in the mess; and toughening agents can improve malleability and physical-mechanical properties of the flame-retardant material. In addition, preservative and mothproof agents can be added in a small amount according to the application of the flame-retardant blanket.

The non-woven fabric carrier is primarily made from natural fibers such as cotton, yarn, silk, linen and agricultural products such as coconut fibers, rice leaves, rice pedicels, grain sorghum and wheat. Alternatively, synthetic fibers or an admixture of the natural and synthetic fibers can be used properly for carriers; for example, polyester fibers, nylon, polystyrene, esterquat, polysulfone, and copolymers or blended fabrics thereof. The carrier of the intumescent flame-retardant material can be any material suitable for weaving.

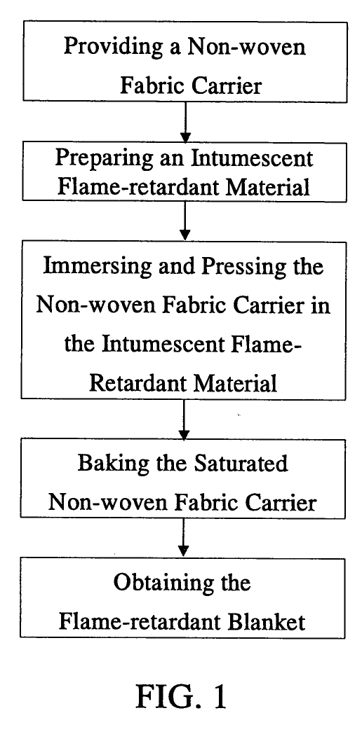

FIG. 1 shows a process for manufacturing the flame-retardant blanket in accordance with the first embodiment of the present invention, which comprises steps of:
(1) providing a non-woven fabric carrier made from natural fibers, synthetic fibers or an admixture thereof;
(2) preparing an intumescent flame-retardant material comprising 20-40% of the inorganic acid, 20-55% of the carbohydrate, 20-50% of the blowing agent, 3-10% of the binder and less than 1% of the auxiliary, in which a weight ratio of the non-woven fabric to the intumescent flame-retardant material ranges from 1:1 to 1:10;
(3) immersing and pressing the non-woven fabric carrier in the intumescent flame-retardant material so that the non-woven fabric carrier can saturate with the flame-retardant material;
(4) baking the non-woven fabric carrier in an oven at 80-140° C. to obtain constant weight; and
(5) obtaining the flame-retardant blanket.

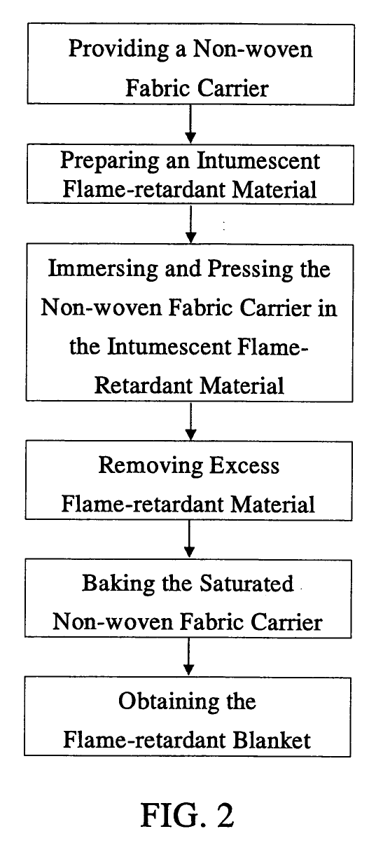

FIG. 2 shows a process for manufacturing the flame-retardant blanket in accordance with the second embodiment of the present invention, which comprises steps of:
(1) providing a non-woven fabric carrier made from natural fibers, synthetic fibers or an admixture thereof;
(2) preparing an intumescent flame-retardant material comprising 20-40% of the inorganic acid, 20-55% of the carbohydrate, 20-50% of the blowing agent, 3-10% of the binder and less than 1% of the auxiliary, in which a weight ratio of the non-woven fabric to the intumescent flame-retardant material ranges from 1:1 to 1:10;
(3) immersing and pressing the non-woven fabric carrier in the intumescent flame-retardant material so that the non-woven fabric carrier can saturate with the flame-retardant material;
(4) removing excess flame-retardant material from the non-woven fabric carrier through a roller squeezer;
(5) baking the non-woven fabric carrier in an oven at 80-140° C. to obtain constant weight; and
(6) obtaining the flame-retardant blanket.

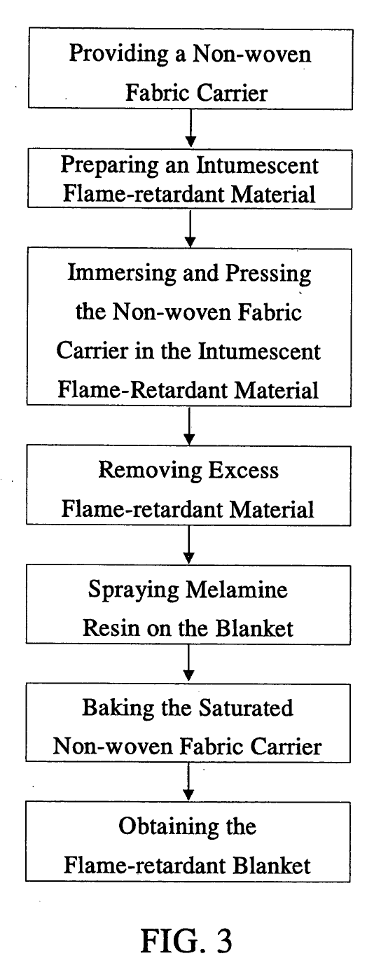

FIG. 3 shows a process for manufacturing the flame-retardant blanket in accordance with the third embodiment of the present invention, which comprises steps of:
(1) providing a non-woven fabric carrier made from natural fibers, synthetic fibers or an admixture thereof;
(2) preparing an intumescent flame-retardant material comprising 20-40% of the inorganic acid, 20-55% of the carbohydrate, 20-50% of the blowing agent, 3-10% of the binder and less than 1% of the auxiliary, in which a weight ratio of the non-woven fabric to the intumescent flame-retardant material ranges from 1:1 to 1:10;
(3) immersing and pressing the non-woven fabric carrier in the intumescent flame-retardant material so that the non-woven fabric carrier can saturate with the flame-retardant material;
(4) removing excess flame-retardant material from the non-woven fabric carrier through a roller squeezer;
(5) spraying melamine formaldehyde resin on surfaces of the non-woven fabric carrier;
(6) baking the non-woven fabric carrier in an oven at 80-140° C. to obtain constant weight; and
(7) obtaining the flame-retardant blanket.

In general, there is much porous space existing in the non-woven fabric made from the synthetic or natural fibers. Therefore, spraying or immersing the non-woven fabric in the intumescent flame-retardant material may fill such porous space with the flame-retardant material through capillarity of the non-woven fabric, and thus the flame-retardant blanket can be obtained.

When suffering high heat or flame, the flame-retardant material in the flame-retardant blanket can decompose, carbonize and expand as large as 10-100 times and fully occupy the porous space of the non-woven fabric carrier. Also, the non-woven fabric dehydrates to form network carbide having a three-dimensioned structure in a condition of high temperature, lacking of oxygen and existence of acidic or alkali catalyst. This network carbide filled and wrapped with the carbonized layer caneform a sponge-like, multi-layered and tight structure. This multi-layered structure possesses superior properties of insulation and resistance to heat and becomes a barrier to the air.

The following tests are performed to show effects of the flame-retardant blanket manufactured in accordance with the present invention.

### Test 1

A non-woven fabric carrier made from long-fibered sisal and having a thickness of 8 mm and a density of 0.8 kg/m² was provided. An intumescent flame-retardant material was prepared by dissolving urea (20 g) and diammonium phosphate (15 g) in water (100 g). After completely dissolved, starch (25 g) was added and dissolved. The sisal non-woven fabric (15 g) was then immersed and pressed in the flame-retardant material for saturating with the solution. The blanket saturated with the solution is weighed as 60 g. After baking in an oven at 100° C. for 2 hours until constant dry weight was obtained, the flame-retardant blanket is 48 g. Then the blanket was burned with a torch at 1200° C. for 20 minutes. Consequently, the blanket rapidly dehydrated and carbonized to a nonflammable object and the flame instantly extinguished when the torch was moved away, and no ember or ash occurred. This test showed that the flame-retardant material performed good flame-retardant effect.

### Test 2

A non-woven fabric carrier made from coconut fibers with needle punched and having a thickness of 15 mm and a density of 1.5 kg/m² was provided. An intumescent flame-retardant material was prepared by dissolving urea (0.9 kg), diammonium phosphate (0.3 kg), mono-ammonium phosphate (0.3 kg), boric acid (0.1 kg) and ethoxy nonyl phenol (20%) (2 g) in water (1.4 kg). After completely dissolving, starch (1 kg) and molasses (45%) 2 kg were added and dissolved. The coconut non-woven fabric (61.5 cm×31.5 cm) was then immersed and pressed in the flame-retardant material for saturating with the solution. The saturated carrier was then passed through rollers having a 5 mm gap to squeeze away excess flame-retardant material. After baking in an oven at 90-100° C. for 2 hours until constant dry weight was obtained, the flame-retardant blanket was 1.074 kg and thickness was 13 mm. Density of the dried blanket is 0.43 g/cc. Then the blanket was burned with a torch at 1200° C. in a perpendicular direction. After 10 minutes, the flame still could not burn through the blanket and instantly extinguished while when torch was moved away from the subject, the blanket shows no ember or ash. This test proved that the flame-retardant material also display good flame-retardant effect.

### Test 3

A non-woven fabric carrier made from polyester fibers blended with a small content of wool and having a thickness of 15 mm and a density of 1.5 kg/m² was provided. An intumescent flame-retardant material was prepared by dissolving urea (1.8 kg), diammonium phosphate (0.9 kg), mono-ammonium phosphate (0.9 kg), boric acid (0.3 kg) and ethoxy nonyl phenol (20%) (10 g) in water (2.8 kg). After completely dissolved, starch (3 kg) was added and dissolved. The non-woven fabric. (386 g) was then immersed and pressed in the flame-retardant material for saturating with the solution. The saturated carrier was then passed through the squeezer having a 3 mm gap to squeeze away excess flame-retardant material, and the wet weight thereof was 1.537 kg. After baking in an oven at 90-100° C. for 2 hours until constant dry weight was obtained, the flame-retardant blanket was 1.074 kg. Then the blanket was burned with a torch at 1200° C. in a perpendicular direction. After 10 minutes, the flame still could not burn through the blanket and instantly extinguished while torch was moved away from the subject, the blanket shows no ember or ash. This test also proved that the flame-retardant material performed good flame-retardant effect.

### Test 4

A non-woven fabric carrier and an intumescent flame-retardant material as the same as Test 3 were provided. The non-woven fabric (366 g) was then immersed and pressed in the flame-retardant material for saturating with the solution. The saturated carrier was then passed through roller squeezer having a 3 mm gap to squeeze away excess flame-retardant material, and the wet weight thereof was 1.518 kg. Particularly, this wet blanket was then sprayed with melamine formaldehyde resin (500 g) through a painting sprayer, wherein the melamine formaldehyde resin had a solid content of 56% and viscosity of 47 cps at 25° C. After baking in an oven at 90-100° C. for 2 hours until constant dry weight was obtained, flame-retardant blanket was 1.634 kg. Then the blanket was burned with a torch at 1200° C. in a perpendicular direction. After 10 minutes, the flame still could not burn through the blanket and extinguished while the torch was moved away from the subject, the blanket shows no ember or ash. This test also showed that the flame-retardant material performed good flame-retardant effect.

### Test 5

A non-woven fabric carrier made from polyester fibers and a small content of wool and having a thickness of 15 mm and a density of 1.5 kg/m² was provided. The non-woven fabric (395 g) was then immersed and pressed in melamine for saturating with melamine formaldehyde resin. The melamine formaldehyde resin solution had a solid content of 56% and viscosity of 47 cps at 25° C. The saturated carrier was then passed through the roller squeezer having a 3 mm gap to squeeze away excess flame-retardant material, and the wet weight thereof was 1.254 kg. After baking in an oven at 90-100° C. for 2 hours until constant dry weight was obtained, the flame-retardant blanket was 0.925 kg. Then the blanket was burned with a torch at 1200° C. in a perpendicular direction. After 8 minutes, the flame still could not burn through the blanket and extinguished while the torch was moved away from the subject, the blanket shows no ember or ash. This test also showed that the flame-retardant material performed good flame-retardant effect.

### Test 6

A non-woven fabric carrier made from coconut fibers with needle punched and having a thickness of 15 mm and a density of 1.5 kg/m² was provided. An intumescent flame-retardant material was prepared by uniformly dispersing melamine phosphate(0.3 kg), pentaerythritol (0.1 kg), sodium tripoly phosphate (2 g), ethoxy nonyl phenol (20%) (2 g) in diluted polyvinyl acetate emulsion (1.0 kg, solid content 5%). The coconut-fiber carrier (31.5 cm×30.5 cm) was then immersed and pressed in the flame-retardant material for saturating with the solution. The saturated carrier was then passed through rollers having a 5 mm gap to squeeze away excess flame-retardant material. After baking in an oven at 90-100° C. for 2 hours until constant dry weight was obtained, the flame-retardant blanket was 0.474 kg and thickness thereof was 13 mm. Then the blanket was burned with a torch at 1200° C. in a perpendicular direction. After 10 minutes, the flame still could not burn through the blanket and extinguished while the torch was moved away from the subject, the blanket shows no ember or ash. Next, the blanket was immersed in water for 15 hours and then baked to have constant dry weight 0.466 kg. Again, the blanket was burned with the torch at 1200° C. in a perpendicular direction. After 10 minutes, the flame still can not burn a hole through the blanket and extinguished while the torch was moved away from the subject, the blanket shows no ember or ash. This test also showed that the flame-retardant material could retain good flame-retardant effect regardless immersing in water.

While the preferred embodiments of the invention have been described above, it will be recognized and understood that various modifications may be made therein and the appended claims are intended to cover all the modifications that may fall within the spirit and scope of the invention.

1. A method for manufacturing a flame-retardant blanket, comprising steps of:
(1) providing a non-woven fabric carrier;
(2) preparing an intumescent flame-retardant material comprising 20-40% of an inorganic acid, 20-55% of carbohydrate, 20-50% of a blowing agent, 3-10% of a binder and less than 1% of auxiliary, in which a weight ratio of the non-woven fabric carrier to the intumescent flame-retardant material ranges from 1:1 to 1:10;
(3) immersing and pressing the non-woven fabric carrier in the intumescent flame-retardant material to saturate the non-woven fabric carrier with the flame-retardant material;
(4) baking the saturated non-woven fabric carrier in an oven to constant weight; and
(5) obtaining the flame-retardant blanket.

2. The method as claimed in claim 1, further comprising a step between step (3) and (4), removing excess flame-retardant material from the non-woven fabric carrier.

3. The method as claimed in claim 2, wherein the non-woven fabric carrier is coated with melamine formaldehyde resin after removing the excess flame-retardant material.

4. The method as claimed in claim 1, wherein the non-woven fabric carrier is made from natural fibers or synthetic fibers or an admixture thereof.

5. A method for manufacturing a flame-retardant blanket, comprising steps of:
(1) providing a non-woven fabric carrier;
(2) preparing an intumescent flame-retardant material comprising 20-40% of a salt of an inorganic acid, 20-55% of carbohydrate, 20-50% of a blowing agent, 3-10% of a binder and less than 1% of auxiliary, in which a weight ratio of the non-woven fabric carrier to the intumescent flame-retardant material ranges from 1:1 to 1:10;
(3) immersing and pressing the non-woven fabric carrier in the intumescent flame-retardant material to saturate the non-woven fabric carrier with the flame-retardant material;
(4) baking the saturated non-woven fabric carrier in an oven to constant weight; and
(5) obtaining the flame-retardant blanket.

6. The method as claimed in claim 5, further comprising a step between step (3) and (4), removing excess flame-retardant material from the non-woven fabric carrier.

7. The method as claimed in claim 6, wherein the non-woven fabric carrier is coated with melamine formaldehyde resin after removing the excess flame-retardant material.

8. The method as claimed in claim 5, wherein the non-woven fabric carrier is made from natural fibers or synthetic fibers or an admixture thereof.

9. A method for manufacturing a flame-retardant blanket, comprising steps of:
(1) providing a non-woven fabric carrier;
(2) preparing an intumescent flame-retardant material comprising 20-40% of an ester of an inorganic acid, 20-55% of carbohydrate, 20-50% of a blowing agent, 3-10% of a binder and less than 1% of auxiliary, in which a weight ratio of the non-woven fabric carrier to the intumescent flame-retardant material ranges from 1:1 to 1:10;
(3) immersing and pressing the non-woven fabric carrier in the intumescent flame-retardant material to saturate the non-woven fabric carrier with the flame-retardant material;
(4) baking the saturated non-woven fabric carrier in an oven to constant weight; and
(5) obtaining the flame-retardant blanket.

10. The method as claimed in claim 9, further comprising a step between step (3) and (4), removing excess flame-retardant material from the non-woven fabric carrier.

11. The method as claimed in claim 10, wherein the non-woven fabric carrier is coated with melamine formaldehyde resin after removing the excess flame-retardant material.

12. The method as claimed in claim 9, wherein the non-woven fabric carrier is made from natural fibers or synthetic fibers or an admixture thereof.

13. A method for manufacturing a flame-retardant blanket, comprising steps of:
(1) providing a non-woven fabric carrier;
(2) preparing an intumescent flame-retardant material comprising 20-40% of an amine of an inorganic acid, 20-55% of carbohydrate, 20-50% of a blowing agent, 3-10% of a binder and less than 1% of auxiliary, in which a weight ratio of the non-woven fabric carrier to the intumescent flame-retardant material ranges from 1:1 to 1:10;
(3) immersing and pressing the non-woven fabric carrier in the intumescent flame-retardant material to saturate the non-woven fabric carrier with the flame-retardant material;
(4) baking the saturated non-woven fabric carrier in an oven to constant weight; and
(5) obtaining the flame-retardant blanket.

14. The method as claimed in claim 13, further comprising a step between step (3) and (4), removing excess flame-retardant material from the non-woven fabric carrier.

15. The method as claimed in claim 14, wherein the non-woven fabric carrier is coated with melamine formaldehyde resin after removing the excess flame-retardant material.

16. The method as claimed in claim 13, wherein the non-woven fabric carrier is made from natural fibers or synthetic fibers or an admixture thereof.
